(19) United States
(12) Patent Application Publication
(10) Pub. No.: US 2026/0030623 A1
(43) Pub. Date: Jan. 29, 2026

(54) METHODS AND SYSTEMS FOR DISTRIBUTING AND VALIDATING ALERTS IN A DISTRIBUTED COMPUTING SYSTEM

(71) Applicant: nChain Licensing AG, Zug (CH)

(72) Inventors: Aljaz NOE, London (GB); Arkadiusz KOLODZIEJSKI, London (GB); Chris GIBSON, London (GB); Richard MILLS, London (GB); Jaka PUST, London (GB); Mike RAE, London (GB); Craig Steven WRIGHT, London (GB)

(21) Appl. No.: 18/868,134

(22) PCT Filed: Jun. 2, 2023
(86) PCT No.: PCT/EP2023/064890

§ 371 Date: Nov. 21, 2024

Related U.S. Application Data
(60) Provisional application No. 63/348,262, filed on Jun. 2, 2022.

(51) Int. Cl. G06Q 20/38; G06Q 20/22

(52) U.S. Cl. CPC G06Q 20/389; G06Q 20/223

(57) ABSTRACT

Systems and computer-implemented methods for generating, propagating and handling alert messages on a blockchain network. The alert messages may be generated and sent by an alert administration service to instruct mining nodes to take certain actions, including freezing a transaction outpoint, banning a peer node, invalidating a block, or implementing a confiscation transaction to move assets from a transaction outpoint to another address. An alert handler within the node software at the mining nodes manages the parsing and processing of alerts. Alerts may be sent in P2P message that includes a serialized alert transaction that itself includes the alert message in an output field. A processed alert message results in the alert transaction being included in the mempool and, eventually, the blockchain.

### CROSS REFERENCE TO RELATED APPLICATIONS

This application is the U.S. National Stage of International Application No. PCT/EP2023/064890 filed on Jun. 2, 2023, which claims the benefit of U.S. Provisional Patent Application No. 63/348,262, filed on Jun. 2, 2022, the contents of which are incorporated herein by reference in their entireties.

### TECHNICAL FIELD

The present disclosure relates to blockchain networks and, in particular, to methods and devices for distributing and validating orders in a distributed computing system, such as a blockchain network.

### BACKGROUND

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The transactions in the blockchain are used to perform one or more of the following: to convey a digital asset (i.e. a number of digital tokens), to order a set of journal entries in a virtualised ledger or registry, to receive and process timestamp entries, and/or to time-order index pointers.

In an “output-based” model (sometimes referred to as a UTXO-based model), the data structure of a given transaction includes one or more inputs and one or more outputs. Any spendable output includes an element specifying an amount of the digital asset that is derivable from the proceeding sequence of transactions. The spendable output is sometimes referred to as a UTXO (“unspent transaction output”) or an “outpoint”. In some cases, the protocol may not refer to “outputs” or “outpoints”, but may instead refer to sender addresses and receiver addresses. The output may further include a locking script specifying a condition for the future redemption of the output. A locking script is a predicate defining the conditions necessary to validate and transfer digital tokens or assets. Each input of a transaction (other than a coinbase transaction) includes a pointer (i.e. a reference) to such an output in a preceding transaction, and may further include an unlocking script for unlocking the locking script of the pointed-to output.

One of the principal attractions of blockchain technology, particularly in the cryptocurrency community, is its distributed, consensus-based enforcement mechanism that eliminates the need for a trusted authority or intermediary for transactions. However this creates a problem when fraud or theft occurs in that there is no available mechanism for freezing digital assets or unwinding or undoing a transaction in stolen assets without imposing a network-wide software change.

### BRIEF DESCRIPTION OF THE DRAWINGS

Reference will now be made, by way of example, to the accompanying drawings which show example embodiments of the present application and in which:

FIG. 1 shows an example system for implementing a blockchain;

FIG. 2 illustrates an example transaction protocol;

FIG. 3A shows an example implementation of a client application;

FIG. 3B shows an example of a user interface for the client application;

FIG. 4 illustrates example node software for a blockchain node;

FIG. 5 shows an example system for generating, propagating and handling alert messages;

FIG. 6 shows, in block diagram format, one example implementation of node software configured to handle alert messages;

FIG. 7 shows, in flowchart form, one simplified example method for implementing generating and sending an alert message; and

FIG. 8 shows, in flowchart form, one simplified example method of receiving and processing an alert message;

Like reference numerals are used in the drawings to denote like elements and features.

### DETAILED DESCRIPTION OF EXAMPLES

In one aspect, the present application describes a computer-implemented method that may include identifying, at a mining node in a blockchain network, that a transaction is an alert transaction; extracting an alert message from an output field of the alert transaction; validating, using one or more alert administrator public keys, one or more signatures within the alert message; and based on the one or more signatures being validated, processing an instruction within the alert message, wherein processing includes one of invaliding a block, banning a peer node, freezing a transaction outpoint, or validating and propagating a confiscation transaction.

In some implementations, identifying that a transaction is an alert transaction is at least partly based on identifying an alert code in the output field.

In some implementations, the alert message includes an alert type field signaling one of a predefined set of alert types. The predefined set of alert types may include an information alert, a ban peer alert, an unban peer alert, a freeze alert, an unfreeze alert, an invalidate block alert, a reconsider block alert, and a confiscate alert.

In some implementations, the alert message is a signed serialized alert message and wherein validating the one or more signatures includes extracting the one or more signatures from the signed serialized alert message leaving a null signature field to result in a modified serialized alert message, hashing the modified serialized alert message to obtain a hash result, and verifying the one or more signatures using the hash result and corresponding one or more public keys associated with an alert administration service.

In some implementations, the method may include receiving an alert P2P message over the blockchain network and extracting the alert transaction from the alert P2P message.

In some implementations, the freezing the transaction output includes obtaining the transaction outpoint from the instruction within the alert message and recording the transaction output as frozen within an order database.

In some implementations, the validating and propagating a confiscation transaction includes extracting the confiscation transaction from within the alert message and whitelisting the confiscation transaction within an order database, and wherein validating and propagating the confiscation transaction includes validating based on its inclusion in the whitelist.

In another aspect, the present application describes a computer-implemented method that may include generating an alert message at an alert administration service, the alert message including a null signature field; serializing and hashing the alert message to generate a hash result; signing the hash result using one or more private keys to generate one or more digital signatures; inserting the one or more digital signatures into the null signature field to produce a signed serialized alert message; inserting the signed serialized alert message into an output field of a blockchain transaction; and propagating the blockchain transaction on a blockchain network.

In some implementations, the blockchain transaction is an alert transaction and wherein propagating includes wrapping the alert transaction in an alert P2P message and transmitting the alert P2P message on the blockchain network to a plurality of mining nodes.

In some implementations, the blockchain transaction is an alert transaction, and wherein the output field includes an alert code and the signed serialized alert message.

In some implementations, the alert message includes an alert type and an instruction. In some cases, the alert type is one of a set of predefined alert types, and wherein the predefined set of alert types include, at least, an information alert, a ban peer alert, an unban peer alert, a freeze alert, an unfreeze alert, an invalidate block alert, a reconsider block alert, and a confiscate alert.

In a further aspect, the present application describes a computing device having memory, one or more processors, and computer-executable instructions stored in the memory that, when executed by the one or more processors, cause the one or more processors to carry out at least one of the methods described herein.

In yet another aspect, there may be provided a computer-readable medium storing processor-executable instructions that, when executed by one or more processors, cause the processors to carry out at least one of the methods described herein.

Other example embodiments of the present disclosure will be apparent to those of ordinary skill in the art from a review of the following detailed description in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

Some of the examples provided below will illustrate concepts using the Bitcoin protocol as an illustrative example. It should be understood that the present application is not limited to implementations using that protocol and that the present application may be applied to other blockchain protocols, such as account-based protocols, including Ethereum or others. To the extent that certain terms are considered limited to UTXO-based blockchains, they should be understood to have a non-protocol specific definition. For example, the terms “transaction outpoint” or “transaction outpoint identifier” should be understood as referring to an identifier of a specific “spendable” or transferrable digital asset that results from a blockchain transaction. The transaction outpoint or transaction outpoint identifier typically has one or more conditions associated with the ability to spend or transfer that asset, such as validation of a digital signature associated with the wallet address to which that transaction outpoint refers. The term “digital asset identifier” may be used to refer to transaction outpoints, wallet addresses, public keys from which wallet addresses are derivable, or other identifiers that may be used in a given blockchain protocol to pinpoint the sender of a digital asset and the recipient of a digital asset in a transaction. Example System Overview

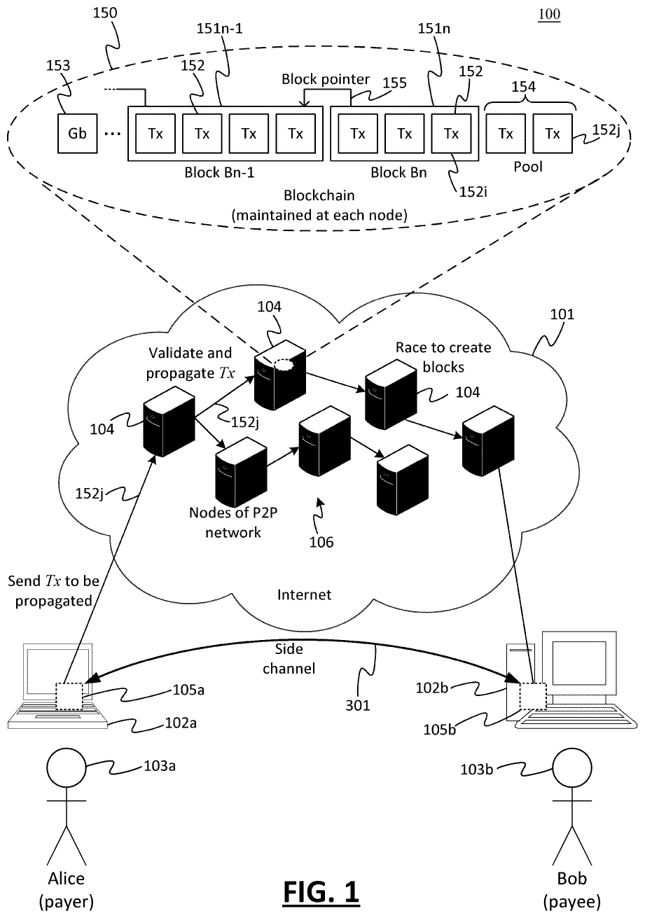

FIG. 1 shows an example system 100 for implementing a blockchain 150. The system 100 may include a packet-switched network 101, typically a wide-area internetwork such as the Internet. The packet-switched network 101 includes a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 includes computer equipment of a peer, with different ones of the nodes 104 belonging to different peers. Each blockchain node 104 includes a processing apparatus implemented by one or more processors, e.g. one or more central processing units (CPUs), accelerator processors, application specific processors and/or field programmable gate arrays (FPGAs), and other equipment such as Application Specific Integrated Circuits (ASICs). Each node also includes memory, i.e. computer-readable storage in the form of a non-transitory computer-readable medium or media. The memory may include one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 includes a chain of blocks of data 151, wherein a respective copy of the blockchain 150 is maintained at each of a plurality of blockchain nodes 104 in the distributed or blockchain network 160. As mentioned above, maintaining a copy of the blockchain 150 does not necessarily mean storing the blockchain 150 in full. Instead, the blockchain 150 may be pruned of data so long as each blockchain node 150 stores the blockheader (discussed below) of each block 151. Each block 151 in the chain includes one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 has at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also includes a block pointer 155 pointing back to the previously created block 151 in the chain so as to define a sequential order to the blocks 151. Each transaction 152 (other than a coinbase transaction) has a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set 154 of transactions 152 waiting to be incorporated into blocks 151. The ordered set 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input includes a pointer referencing the output of a preceding transaction 152i in the sequence of transactions, specifying that this output is to be redeemed or “spent” in the present transaction 152j. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also includes the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when an entity, such as a user or machine, 103 wishes to enact a new transaction 152j, then the entity sends the new transaction from its computer terminal 102 to a recipient. The entity or the recipient will eventually send this transaction to one or more of the blockchain nodes 104 of the network 106 (which nowadays are typically servers or data centres, but could in principle be other user terminals). It is also not excluded that the entity 103 enacting the new transaction 152j could send the transaction to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may include checking that the cryptographic signature or other authorisation of the entity 103 included in the input of the new transaction 152j matches a condition defined in the output of the preceding transaction 152i which the new transaction assigns, wherein this condition typically includes at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.
In an output-based model, the definition of whether a given output (e.g. UTXO) is assigned is whether it has yet been validly redeemed by the input of another, onward transaction 152j according to the blockchain node protocol. Another condition for a transaction to be valid is that the output of the preceding transaction 152i which it attempts to assign or redeem has not already been assigned/redeemed by another transaction. Again if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered set 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically this includes searching for a “nonce” value such that when the nonce is concatenated with a representation of the ordered set of transactions 154 and hashed, then the output of the hash meets a predetermined condition. For example, the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 151n pointing back to the previously created block 151n-1 in the chain. A significant amount of effort, for example in the form of hash, required to create a proof-of-work solution signals the intent of the first node 104 to follow the rules of the blockchain protocol. Such rules include not accepting a transaction as valid if it assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the ordered set of yet to be published transactions 154 at any given time, depending on when they started searching for a solution or the order in which the transactions were received. Whoever solves their respective puzzle first defines which transactions 152 are included in the next new block 151n and in which order, and the current set 154 of unpublished transactions is updated. The blockchain nodes 104 then continue to race to create a block from the newly-defined outstanding ordered set of unpublished transactions 154, and so forth. A protocol also exists for resolving any “fork” that may arise, which is where two blockchain nodes 104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to assign an accepted amount of the digital asset in a new special kind of transaction which distributes a defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee”, and is discussed below.

Due to the resources involved in transaction validation and publication, typically at least each of the blockchain nodes 104 takes the form of a server that includes one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network but do not participate in validating, constructing or propagating transactions and blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus including one or more processors, e.g. one or more CPUs, GPUs, other accelerator processors, application specific processors, and/or FPGAs. The computer equipment 102 of each party 103 further includes memory, i.e. computer-readable storage in the form of a non-transitory computer-readable medium or media. This memory may include one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software such as a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 includes at least one user terminal, e.g. a desktop or laptop computer, a tablet, a smartphone, or a wearable device such as a smartwatch. The computer equipment 102 of a given party 103 may also include one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 includes at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality includes collating the amounts defined in the outputs of the various 152 transactions scattered throughout the blockchain 150 that belong to the party in question.

It will be understood that whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This may include first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered set of transactions 154 maintained at a given blockchain node 104, that blockchain node 104 will start competing to solve the proof-of-work puzzle on the latest version of their respective ordered set of transactions 154 including the new transaction 152 (recall that other blockchain nodes 104 may be trying to solve the puzzle based on a different ordered set of transactions 154, but whoever gets there first will define the ordered set of transactions that are included in the latest block 151, and eventually a blockchain node 104 will solve the puzzle for a part of the ordered set 154 which includes Alice's transaction 152j). Once the proof-of-work has been done for the ordered set 154 including the new transaction 152j, it immutably becomes part of one of the blocks 151 in the blockchain 150. Each transaction 152 includes a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

### UTXO-Based Model

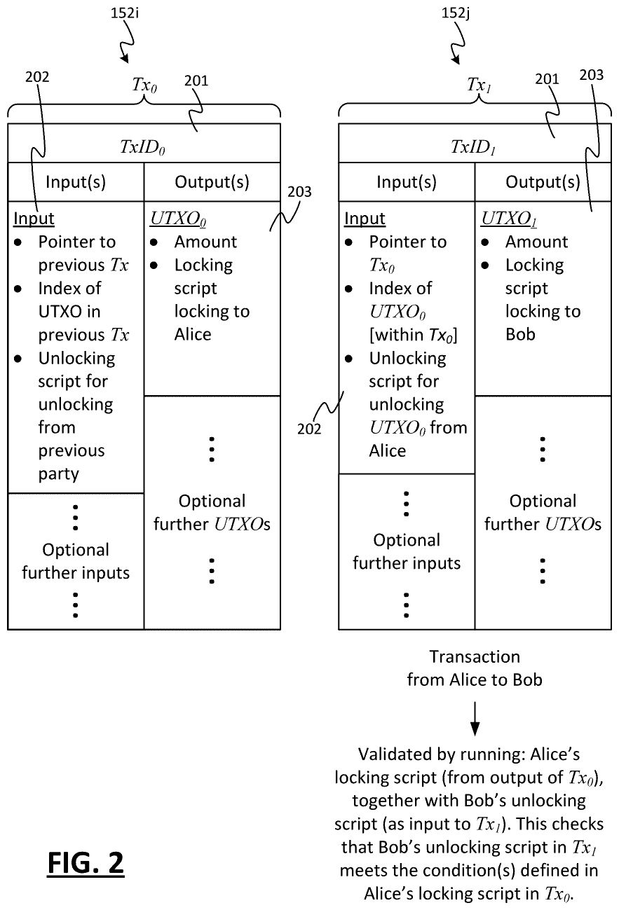

FIG. 2 illustrates an example transaction protocol. This is an example of a UTXO-based protocol. A transaction 152 (abbreviated “Tx”) is the fundamental data structure of the blockchain 150 (each block 151 containing one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 is a data structure having one or more inputs 202, and one or more outputs 203. Each output 203 may include an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also include a header 201, which may include an indicator of the size of the input field(s) 202 and output field(s) 203. The header 201 may also include an ID of the transaction. In some embodiments, the transaction ID is the hash of the transaction data (excluding the transaction ID itself).

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in a block 151 of the blockchain 150 at the time when Alice creates her new transaction Tx₁, or at least by the time she sends it to the network 106. It may already have been included in one of the blocks 151 at that time, or it may be still waiting in the ordered set 154 in which case it will soon be included in a new block 151. Alternatively Tx₀ and Tx₁ could be created and sent to the network 106 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ is a particular UTXO, labelled here UTXO₀. Each UTXO includes a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). That is, the locking script defines an unlocking condition, typically include a condition that the unlocking script in the input of the subsequent transaction include the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Locking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ includes a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ includes a pointer pointing back to Tx₀ (e.g. by means of its transaction ID, TxID₀, which in some embodiments is the hash of the whole transaction Tx₀). The input 202 of Tx₁ includes an index identifying UTXO₀ within Tx₀, to identify it amongst any other possible outputs of Tx₀. The input 202 of Tx₁ further includes an unlocking script <Sig P_{A}> which has a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This may include running the locking script and unlocking script together to check whether the unlocking script meets the condition defined in the locking script (where this condition may include one or more criteria). In some embodiments this may involve concatenating the two scripts:

$$< Sig {P}_{A} > < {P}_{A} > ‖ [ Checksig {P}_{A} ]$$

where “∥” represents a concatenation and “< . . . >” means place the data on the stack, and “[ . . . ]” is a function carried out by the locking script (in this example a stack-based language). Equivalently the scripts may be run one after the other, with a common stack, rather than concatenating the scripts. Either way, when run together, the scripts use the public key P_{A} of Alice, as included in the locking script in the output of Tx₀, to authenticate that the unlocking script in the input of Tx₁ contains the signature of Alice signing the expected portion of data. The expected portion of data itself (the “message”) also needs to be included in order to perform this authentication. In one embodiment the signed data includes the whole of Tx₁ (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically includes hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the blockchain node 104 deems Tx₁ valid. This means that the blockchain node 104 will add Tx₁ to the ordered set of transactions 154. The blockchain node 104 will also forward the transaction Tx₁ to one or more other blockchain nodes 104 in the network 106, so that it will be propagated throughout the network 106. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice, a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However, the amount from the UTXO can be split between multiple outputs of the next transaction. For example, the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the bitcoin node that publishes her transaction 104. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. For example, say a pointer to UTXO₀ is the only input to Tx₁, and Tx₁ has only one output UTXO₁. If the amount of the digital asset specified in UTXO₀ is greater than the amount specified in UTXO₁, then the difference may be assigned by the node 104 that publishes the block containing UTXO₁. Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence, typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP_. . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. For example, the data could include a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically includes the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed includes authenticating a signature. More generally the scripting language could be used to define any one or more conditions. Hence the more general terms “locking script” and “unlocking script” may be preferred.

As shown in FIG. 1, the client application on each of Alice and Bob's computer equipment 102a, 120b, respectively, may include additional communication functionality. This additional functionality enables Alice 103a to establish a separate side channel 301 with Bob 103b (at the instigation of either party or a third party). The side channel 301 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 301 may be used to exchange any other transaction related data, such as keys, negotiated amounts or terms, data content, etc.

The side channel 301 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 301 as referred to anywhere herein may include any one or more links via one or more networking technologies or communication media for exchanging data “off-chain”, i.e. separately from the blockchain network 106. Where more than one link is used, then the bundle or collection of off-chain links as a whole may be referred to as the side channel 301. Note therefore that if it is said that Alice and Bob exchange certain pieces of information or data, or such like, over the side channel 301, then this does not necessarily imply all these pieces of data have to be send over exactly the same link or even the same type of network.

### Client Software

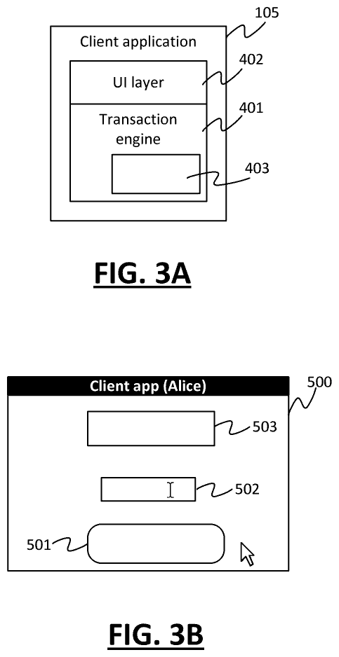

FIG. 3A illustrates an example implementation of the client application 105 for implementing embodiments of the presently disclosed scheme. The client application 105 may include a transaction engine 401 and a user interface (UI) layer 402. The transaction engine 401 is configured to implement the underlying transaction-related functionality of the client 105, such as to formulate transactions 152, receive and/or send transactions and/or other data over the side channel 301, and/or send transactions to one or more nodes 104 to be propagated through the blockchain network 106, in accordance with the processes discussed above.

The UI layer 402 is configured to render a user interface via a user input/output (I/O) means of the respective user's computer equipment 102, including outputting information to the respective user 103 via a user output means of the equipment 102, and receiving inputs back from the respective user 103 via a user input means of the equipment 102. For example the user output means could include one or more display screens (touch or non-touch screen) for providing a visual output, one or more speakers for providing an audio output, and/or one or more haptic output devices for providing a tactile output, etc. The user input means could include for example the input array of one or more touch screens (the same or different as that/those used for the output means); one or more cursor-based devices such as mouse, trackpad or trackball; one or more microphones and speech or voice recognition algorithms for receiving a speech or vocal input; one or more gesture-based input devices for receiving the input in the form of manual or bodily gestures; or one or more mechanical buttons, switches or joysticks, etc.

Note that whilst the various functionality herein may be described as being integrated into the same client application 105, this is not necessarily limiting and instead they could be implemented in a suite of two or more distinct applications, e.g. one being a plug-in to the other or interfacing via an API (application programming interface). For instance, the functionality of the transaction engine 401 may be implemented in a separate application than the UI layer 402, or the functionality of a given module such as the transaction engine 401 could be split between more than one application. Nor is it excluded that some or all of the described functionality could be implemented at, say, the operating system layer. Where reference is made anywhere herein to a single or given application 105, or such like, it will be appreciated that this is just by way of example, and more generally the described functionality could be implemented in any form of software.

FIG. 3B gives a mock-up of an example of the user interface (UI) 500 which may be rendered by the UI layer 402 of the client application 105a on Alice's equipment 102a. It will be appreciated that a similar UI may be rendered by the client 105b on Bob's equipment 102b, or that of any other party.

By way of illustration FIG. 3B shows the UI 500 from Alice's perspective. The UI 500 may include one or more UI elements 501, 502, 502 rendered as distinct UI elements via the user output means.

For example, the UI elements may include one or more user-selectable elements 501 which may be, such as different on-screen buttons, or different options in a menu, or such like. The user input means is arranged to enable the user 103 (in this case Alice 103a) to select or otherwise operate one of the options, such as by clicking or touching the UI element on-screen, or speaking a name of the desired option (N.B. the term “manual” as used herein is meant only to contrast against automatic, and does not necessarily limit to the use of the hand or hands).

Alternatively or additionally, the UI elements may include one or more data entry fields 502. These data entry fields 502 are rendered via the user output means, e.g. on-screen, and the data can be entered into the fields through the user input means, e.g. a keyboard or touchscreen. Alternatively the data could be received orally for example based on speech recognition.

Alternatively or additionally, the UI elements may include one or more information elements 503 output to output information to the user. For example, the information could be rendered on screen or audibly.

It will be appreciated that the particular means of rendering the various UI elements, selecting the options and entering data is not material. The functionality of these UI elements will be discussed in more detail shortly. It will also be appreciated that the UI 500 shown in FIG. 3B is only a schematized mock-up and in practice it may include one or more further UI elements, which for conciseness are not illustrated.

### Node Software

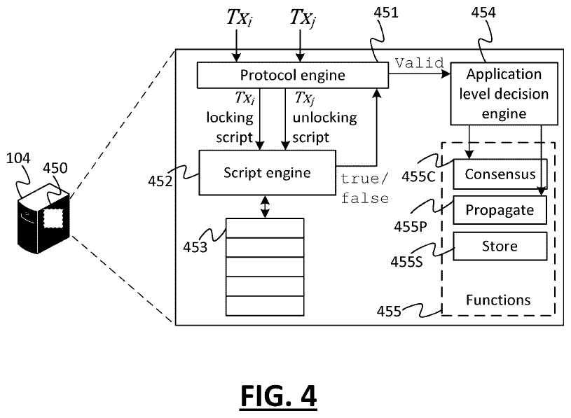

FIG. 4 illustrates an example of the node software 450 that is run on each blockchain node 104 of the network 106, in the example of a UTXO- or output-based model. Note that another entity may run node software 450 without being classed as a node 104 on the network 106, i.e. without performing the actions required of a node 104. The node software 450 may contain, but is not limited to, a protocol engine 451, a script engine 452, a stack 453, an application-level decision engine 454, and a set of one or more blockchain-related functional modules 455. Each node 104 may run node software that contains, but is not limited to, all three of: a consensus module 455C (for example, proof-of-work), a propagation module 455P and a storage module 455S (for example, a database). The protocol engine 401 is typically configured to recognize the different fields of a transaction 152 and process them in accordance with the node protocol. When a transaction 152j (Txⱼ) is received having an input pointing to an output (e.g. UTXO) of another, preceding transaction 152i (Txₘ₋₁), then the protocol engine 451 identifies the unlocking script in Txⱼ and passes it to the script engine 452. The protocol engine 451 also identifies and retrieves Txᵢ based on the pointer in the input of Txⱼ. Txᵢ may be published on the blockchain 150, in which case the protocol engine may retrieve Txᵢ from a copy of a block 151 of the blockchain 150 stored at the node 104. Alternatively, Txᵢ may yet to have been published on the blockchain 150. In that case, the protocol engine 451 may retrieve Txᵢ from the ordered set 154 of unpublished transactions maintained by the node 104. Either way, the script engine 451 identifies the locking script in the referenced output of Tx₁ and passes this to the script engine 452.

The script engine 452 thus has the locking script of Txᵢ and the unlocking script from the corresponding input of Txⱼ. For example, transactions labelled Tx₀ and Txᵢ are illustrated in FIG. 2, but the same could apply for any pair of transactions. The script engine 452 runs the two scripts together as discussed previously, which will include placing data onto and retrieving data from the stack 453 in accordance with the stack-based scripting language being used (e.g. Script).

By running the scripts together, the script engine 452 determines whether or not the unlocking script meets the one or more criteria defined in the locking script—i.e. does it “unlock” the output in which the locking script is included? The script engine 452 returns a result of this determination to the protocol engine 451. If the script engine 452 determines that the unlocking script does meet the one or more criteria specified in the corresponding locking script, then it returns the result “true”. Otherwise it returns the result “false”.

In an output-based model, the result “true” from the script engine 452 is one of the conditions for validity of the transaction. Typically there are also one or more further, protocol-level conditions evaluated by the protocol engine 451 that must be met as well; such as that the total amount of digital asset specified in the output(s) of Txⱼ does not exceed the total amount pointed to by its inputs, and that the pointed-to output of Txᵢ has not already been spent by another valid transaction. The protocol engine 451 evaluates the result from the script engine 452 together with the one or more protocol-level conditions, and only if they are all true does it validate the transaction Txⱼ. The protocol engine 451 outputs an indication of whether the transaction is valid to the application-level decision engine 454. Only on condition that Txⱼ is indeed validated, the decision engine 454 may select to control both of the consensus module 455C and the propagation module 455P to perform their respective blockchain-related function in respect of Txⱼ. This may include the consensus module 455C adding Txⱼ to the node's respective ordered set of transactions 154 for incorporating in a block 151, and the propagation module 455P forwarding Txⱼ to another blockchain node 104 in the network 106. Optionally, in embodiments the application-level decision engine 454 may apply one or more additional conditions before triggering either or both of these functions. For example, the decision engine may only select to publish the transaction on condition that the transaction is both valid and leaves enough of a transaction fee.

Note also that the terms “true” and “false” herein do not necessarily limit to returning a result represented in the form of only a single binary digit (bit), though that is certainly one possible implementation. More generally, “true” can refer to any state indicative of a successful or affirmative outcome, and “false” can refer to any state indicative of an unsuccessful or non-affirmative outcome. For instance in an account-based model, a result of “true” could be indicated by a combination of an implicit, protocol-level validation of a signature and an additional affirmative output of a smart contract (the overall result being deemed to signal true if both individual outcomes are true).

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In some embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In some other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “node”, “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

### Alert Generation and Handling

One of the reasons for interest in public blockchain networks for digital assets is that they can be used for permissionless trustless transactions. By eliminating the need for a central authority or trusted entity to facilitate transfers, blockchain networks enable a holder of a digital asset direct control over the digital asset and movement of the digital asset to another wallet. However, this also creates a challenge to the existing regulatory or legal framework. Without a mechanism to seize, control, or otherwise force transfer of assets, it can be difficult or impossible to apply court orders to digital assets, even when trying to address clear demonstrable fraud or theft.

The growth in interest and investment in cryptocurrencies and other blockchain-based digital asset systems, such as NFTs, has also prompted a significant level of fraud and malicious behaviour. There are many instances of digital assets being ‘stolen’ through theft of private keys or through obtaining access to the private keys by subterfuge or deception. In some cases, online exchanges have been compromised or have been discovered to have been fraudulent. Governments, courts, and the financial industry are grappling with how to apply conventional tools of enforcement or justice to blockchain-based digital assets.

Attempts to deal with real-world theft, bankruptcy and fraud that impact blockchain-based digital assets might lead courts or other legal or government entities to issue orders to a blockchain organization, blockchain miners, or individual blockchain code programmers. Those orders might direct the recipient to freeze or block further transactions in identifiable digital assets and/or to take those assets into custody or escrow. Some blockchain software may lack the capacity to implement those actions such that implementation requires a making a change to software operating the nodes of the blockchain network. This can lead to forking of the chain as some nodes may employ the updated software and some may not.

One possible option for managing orders of this nature or dealing with fraud within the blockchain network is to instruct mining nodes to carry out certain orders. The instructions may be sent externally to the blockchain network. The downside to this approach is that it compromises the record and integrity of the blockchain.

The present application provides for methods and systems of implementing orders, such as freeze, ban, invalidate, or confiscate orders, within the blockchain network using P2P messaging. An alert administration service may be charged with responsibility for vetting and issuing alerts instructing mining nodes to carry out particular instructions or orders. As will be described below, advantageously the service may encapsulate an alert message within an alert transaction that may itself be processed using normal transaction validation operations such that it is added to a mempool and eventually incorporated in the blockchain. This ensures the alert is recorded on chain in the normal course of operations. It also leverages the existing transaction validation and mempool operations. An alert handler within the mining node manages the validation of alert messages extracted from alert transactions, including the signatures applied by the alert administration service.

In some example implementations, instructions in an alert message may include instructions to freeze or unfreeze particular UXTOs; instructions to confiscate certain UTXOs by way of a confiscation transaction that transfers the assets associated with that UTXO to another UTXO; instructions to ban a peer node or to unban a peer node; instructions to invalidate a block or to reconsider a block; or mere informational content.

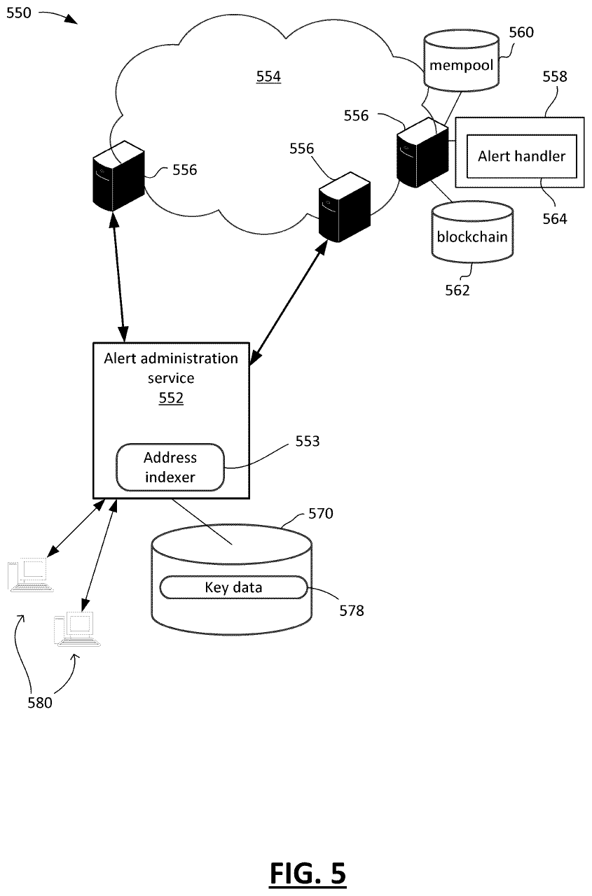

Reference is first made to FIG. 5, which shows a simplified illustration of an example system 550 for generating and propagating instructions to mining nodes in a blockchain system. The system 550 may include an alert administration service 552. The alert administration service 552 may be implemented using one or more computing devices. In some cases, the alert administration service 552 is a web service. One or more user devices 580 may connected to the alert administration service 552, for example using a web browser or dedicated application, in order to instruct or cause the alert administration service 552 to generate and propagate an instruction intended to cause the mining nodes to take a particular action. The user devices 580 provide user credentials that are authenticated by the alert administration service 552. Different levels of permissions may be allocated to different user types in some implementations.

The alert administration service 552 is configured to communicate with mining nodes 556 that collectively form a blockchain network 554. Each mining node 556 is usually implemented using dedicated special-purpose computing devices designed for blockchain mining operations. In some cases, one or more of the mining nodes 556 may be a mining pool, which may include a number of mining node instances.

Each mining node 556 may store and maintain a copy of the blockchain 562. As new blocks are confirmed (i.e. validated) by the mining node 556, it adds that new block to its copy of the blockchain 562. If a mining node 556 goes offline for a period of time or is newly instantiated and added to the blockchain network 554, it may conduct an initial blockchain download (IBD) or may request copies of most recent blocks missing from its chain in order to complete its picture of the current state of the blockchain 562. Each mining node 556 may further maintain a mempool 560, which is a data structure, such as a database, stored in memory and containing unconfirmed blockchain transactions.

The mining nodes 556 each implement at least one mining node instance, based on mining node software 558 stored in memory and executed by one or more processors. The mining node software 558 may include a portion configured to implement an alert handler 564, which enables the mining node 556 to identify, validate, and take action based on alert messages sent by the alert administration service 552.

In general terms, the alert administration service 552 receives authenticated instructions from one of the user devices 580 to issue an alert message. The alert message may include an alert type. Different alert types may include, for example, information, instructions to freeze/unfreeze a UTXO, instructions to ban/unban a peer node, instructions to invalidate a block or reconsider a block, and/or instructions to confiscate assets by way of a confiscate transaction that moves assets from a UTXO to another UTXO.

The alert administration service 552 may, in some cases, require that certain instructions, such as a freeze or confiscate instruction, be based on a validated court identifier or other credentials that indicate that the instruction implements an action authorized by a legal authority. In some cases, the alert administration service 552 may convert a received court order from one of the user devices 580 to a machine-readable representation of the court order. In some implementations, one or more digital signature from entities authorized to sign court orders may be verified by the alert administration service 552. The court order may specify one or more digital assets. The digital asset identifiers may pinpoint particular addresses, e.g. wallet addresses, which are to be frozen or confiscated as a result of the court order. In some instances, the court order may also or alternatively identify digital assets by way of transaction outpoint, e.g. a UTXO; however, in many cases the court order may identify funds by way of their association with a wallet address or other public key representation.

The alert administration service 552 may include an address indexer 553 configured to convert a wallet address or other public key address to one or more transaction outpoints. It will be appreciated that a single address may be associated with a plurality of digital assets, which (in the case of some blockchains) may be identified by way of the transaction outpoint allocating the asset to that single address. For example, a single public key hash address may be the recipient address for many transactions allocating digital assets, like cryptocurrency or NFTs, to that address. Each outpoint in a transaction that sends digital assets to that address may be identified by the address indexer 553. The address indexer 553 or an associated service may further be configured to engage in children discovery, i.e., tracing operations, to track assets that have been moved from an identified address to one or more other address and the associated outpoints from the transactions that carried out those movements. In some implementations the address indexer 553 is implemented as part of a general blockchain indexer configured to obtain new block data and to index transactions linking spent transaction outpoints to transaction inputs to enable tracing of digital assets through transactions. The blockchain indexer may connect to one or more blockchain nodes to listen for new blocks and to retrieve block data.

The alert administration service 552 may store key data 578, including its own public key(s) and securely stored private key(s). In some cases, the key data 578 may include public key data associated with registered or authenticated mining nodes 556. In some cases, this may include a minerID registered on chain and associated with a specific miner. In some cases, the key data 578 includes coinbase public key data. In some cases, the key data 578 may include delegated key data linked to a minerID or to coinbase public key data. In some cases, the key data 578 may include a plurality of private keys and may be utilized for signing of alert messages. In some implementations, alert messages may be signed using multiple signatures. In some implementations, a threshold signature scheme requiring N ofM signatures may be used. The keys involved may change over time using a defined key rotation scheme.

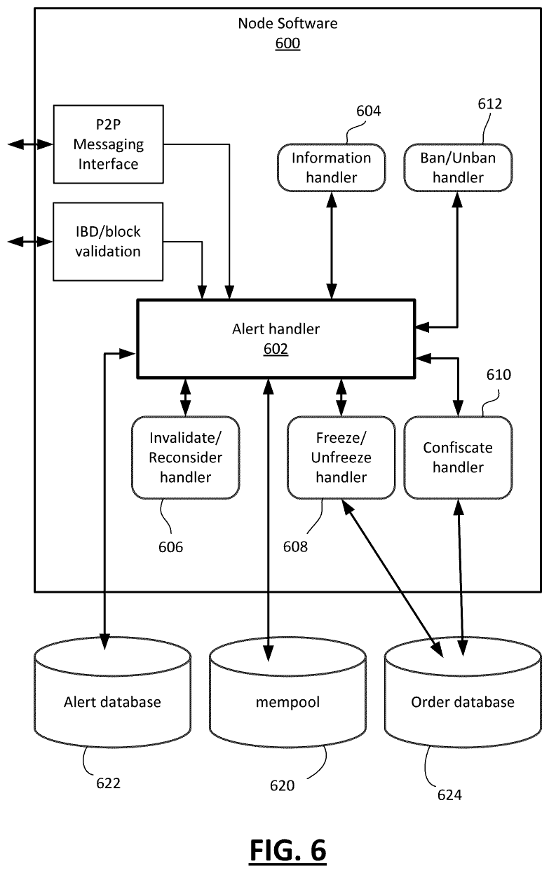

Reference is now made to FIG. 6, which shows, in block diagram format, one example of node software 600 for operating a node of a blockchain network capable of receiving and handling alert messages from an alert administration service. The node software 600 is illustrated in conceptual operational or functional blocks that may be practically implemented as separate modules or applications, or in combination or sub-combination with each other in one or more modules or applications. The executable code that implements the node software 600 may be implemented using any programming language suitable for the processing hardware and operating system within which it is executed. The node software 600 is generally stored in memory within the blockchain node and is executed by one or more processors or processing units. The blockchain node may be a mining node.

The node software 600 include modules or components (not shown) for carrying out the functions of the blockchain node in accordance with the applicable blockchain protocol, such as, for example, normal transaction validation and propagation operations and/or mining operations. In this example, the node software 600 includes an alert handler 602 and a number of sub-handlers that may be called by the alert handler 602 for processing of particular alerts. The sub-handlers in this example include an information handler 604, an invalidate/reconsider handler 606, a freeze/unfreeze handler 608, a confiscate handler 610, and a ban/unban handler 612. While this example and the description below treats the sub-handlers as separate components from the alert handler 602, in some implementations some or all of the functions of the sub-handlers may be implemented within the alert handler 602.

The alert handler 602 is configured to carry out initial processing of new alerts. New alerts are typically received by the blockchain node by way of an alert P2P message via a P2P messaging interface 614. In some cases, however, alerts may be discovered within newly-mined blocks or, in the case of a new blockchain node or a blockchain node returning to the network after a period of disconnection, within existing blocks on the chain that the node receives and validates so as to build its picture of the state of the blockchain, e.g. during an initial block download (IBD). The node software 600 may include a block validation component 626 configured to obtain block data from peer nodes during an IBD process and may pass alert transactions to the alert handler 602.

As will be discussed further below, an alert message is embedded within an alert transaction. In the case of an alert P2P message, the alert transaction itself may be enveloped within the format of an alert P2P message; however, in some implementations the alert transaction may be received in as a normal P2P transaction over the P2P network. The alert transaction contains the alert message within an output field. In some cases, the output field may include an alert code or other signifier to indicate that the rest of the contents of the output field is an alert message, typically in serialized form. The alert message itself may be a JSON formatted string in some cases.

Each alert message may include a sequence number in some implementations to enable nodes to determine an ordering of alerts and, in some cases, to identify duplicate alert messages. Each alert message may further include an alert type signalling the type of instruction being provided within the alert message from the alert administration service, and may include a message payload or field providing the instruction. The content of the message payload or field may vary dependent upon the alert type. For example, an information alert may permit an unstructured message field that enables inclusion of any ASCII string content. A freeze/unfreeze instruction may require that the message field contain references to one or more transaction outpoints. The alert message also contains a signature field that contains one or more digital signatures from the alert administration service to enable the nodes to validate that the alert message is legitimate.

The alert handler 602 is configured to validate the alert message, confirm that the alert message was not previously processed by the node, and, if not, then to hand of the alert to the appropriate sub-handler for processing. Once the alert has been processed by the node, the alert handler 602 is configured to add the alert transaction to its mempool 620. In this way, if the node mines the next block then the alert transaction will be included in the block as a digital record of the fact it was validated and processed by the node. If another node mines the next block and it contains the alert transaction, the node is able to validate that block and to remove the alert transaction from its mempool 620.

The alert handler 602 may propagate validated alert P2P messages to other nodes over the P2P network. In some cases, the alert handler 602 only causes propagation of the alert P2P message after processing of the alert instruction has been completed; however, in some other cases, the processing may be asynchronous and the node software 600 may be configured to propagate the alert P2P message before processing has been completed and before the alert transaction has been added to its mempool 620.

In some cases, if the alert transaction is not encapsulated in the alert P2P message, then the node software 600 may be configured to propagate the alert transaction in the normal course of transaction propagation once it has been validated.

The alert handler 602 maintains an alert database 622. The alert database 622 is a record of all received alert messages. It may be used to record both the alert contents and the processing status of the alert at the node. In some cases, it may have a scheme such as:

| Key | Values | Description |
|---|---|---|
| Alert sequence | JSON | The full alert message in JSON representation |
| number | | |
| | Source | A Boolean flag to indicate whether the alert was received in an |
| | | alert P2P message or discovered in a block |
| | Status | A Boolean flag to indicate whether it has been processed |
| | Warnings | A string containing any warning message returned by a sub- |
| | | handler when processing this alert |
| | Errors | A string containing any error message returned by a sub-handler |
| | | when processing this alert |

An example of a warning message may be that the alert instructed the node to freeze a UTXO that is already frozen. An example of an error message may be that the alert instructed the node to freeze a UTXO that does not appear to exist.

In another example, instead of a Boolean flag, a two-bit field may be used to signal whether the alert is processed, unprocessed, or whether an error was generated. A single message field may be defined for containing any warning or error messages.

The information handler 604 may be configured to extract and log any information strings provided in an information-type alert message. The information handler 604 may be configured to perform some notification or messaging function based on the information in some cases. In some cases, the information handler 604 may only log the information within memory at the node.

The invalidate/reconsider handler 606 is configured to process an instruction to invalidate a block or, if a block has previously been invalidated, to “reconsider”, e.g. re-validate, a block. In response to an invalidate instruction in an alert message, the invalidate/reconsider handler 606 may cause the invalidation and/or discarding of a block on the blockchain maintained at the node. In most use cases, this may be a most-recent block; however, in some cases, the invalidation instruction may specify an older block, which would result in invalidation of that block and all subsequent blocks on its chain.

The freeze/unfreeze handler 608 is configured to process instructions to freeze a transaction outpoint, e.g. a UTXO, or to unfreeze a previously-frozen transaction outpoint. The freeze/unfreeze handler 608 may maintain an order database 624 that tracks transaction outpoints that have been frozen/unfrozen.

The confiscate handler 610 is configured to process confiscate instructions. A confiscate instruction in a confiscate alert provides a confiscate transaction that moves digital assets from a specified one or more transaction outpoints to a different one or more transaction outpoints. The confiscate instruction may be used to force the transfer of digital assets to give effect to a seizure, such as to implement a court order for example. The confiscation handler 610 may be configured to whitelist the confiscation transaction within the order database 624 to signal that it is to be treated as a valid transaction. In some cases, the confiscation handler 610 may require that any inputs to the confiscation transaction are previously-frozen UTXOs already recorded in the order database 624. The confiscation handler 610 may submit the confiscation transaction to the transaction validation process within the node software 600 so it can be added to the mempool 620.

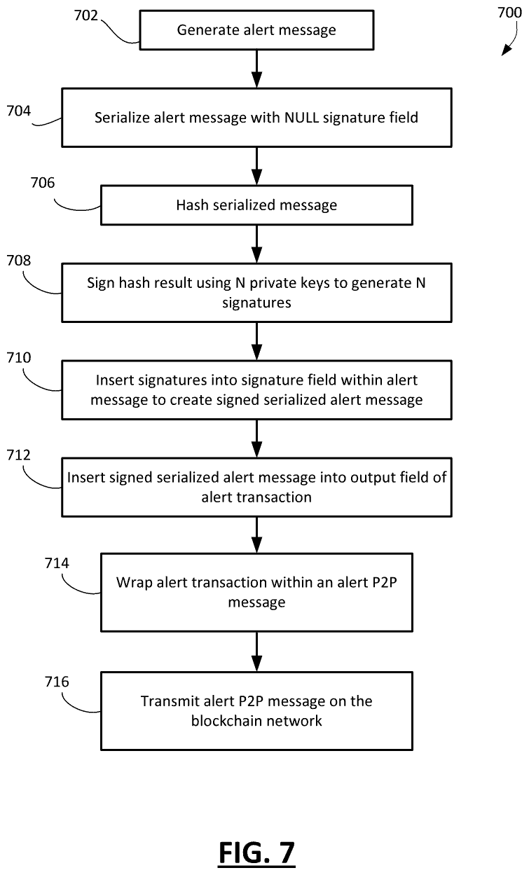

Reference will now be made to FIG. 7, which shows, in flowchart form, one example method 700 for generating and propagating an alert message. The method 700 may be implemented using a network-connected computing device. In some cases, the computing device may be a server or group of servers operating an online service, such as the alert administration service 552 (FIG. 5). The operations of the method 700 may be carried out by the computing device based on processor-executed software instructions stored in memory on the computing device. The computing device may be connected to one or more networks, such as the Internet. The computing device may or may not be directly connected to the blockchain network as a node of the blockchain network. In many implementations, the computing device does not operate blockchain protocol software and does not form part of the blockchain network, but is configured to obtain data from one or more blockchain nodes and to send and receive data with one or more nodes, such as a mining nodes, on the blockchain network. The computing device may be configured to communicate with the one or more modes using a P2P communication protocol.

In operation 702, the alert administration service generates an alert message. As noted above, the alert message may have a defined structure and may contain a sequence number, an alert type, an instruction, and one or more digital signatures. One example of an alert message structure is shown below:

```
{
  “version” : number,
  “sequenceNumber” : number,
    “blockHeight” : number,
    “timestamp” : string,
  “reference” : string,
    “alertType” : string,
    “alert” : {
      ...
    },
    “signature” : {
      “multisig” : [string]
    }
}
```

The version field may signal a version of the alert messaging protocol being employed if there is more than one version. The sequenceNumber field may server as a unique ID for the alert and as a sequence number to enable nodes to know in which order to process received alert messages. The blockHeight field may signal the block height at the time the alert is generated. The timestamp field contains the time at which the alert was generated, for example in ISO-8601 format. The reference field may store an optional reference for the alert. The alertType field may signal what type of alert is contained in the alert object field. An alert handler may route an alert for processing based on its alertType. The alert object field contains the alert details. This may include an instruction and the format and content may vary depending on the alertType. The signature object contains the signatures generated and inserted by the alert administration service.

In some cases the alert types may include “information”, “invalidate_block”, “reconsider_block”, “ban_peer”, “unban_peer”, “freeze_order”, “unfreeze_order”, and “confiscate”. The content of the alert object for these various types may vary. The information type alert may simply contain a string for the receiving node to log. The invalidate_block alert type and the reconsider_block alert types may have a string specifying the hash of the block to invalidate or reconsider. The ban_peer or unban_peer alert types may specifiy an IP address or a subnet to be banned or unbanned.

The freeze_order alert type and the unfreeze_order alert type may specify the transaction outpoint, or a list of transaction outpoints, that should be frozen. It may take the form:

```
{
  “funds” : [
    {
      “txid” : string,
      “vout” : number
    }
  ]
}
```

The confiscate alert type may contain a string that is a confiscate transaction designed to move asserts from one or more transaction outpoints to one or more other addresses. In some cases, it may contain more than one confiscate transaction. Each confiscate transaction may be inserted as a hex-string encoded transaction. The confiscate handler is to decode and whitelist the transaction in the order database and submit the transaction for validation and inclusion in the mempool.

The alert handler is to generate and include one or more digital signatures in the alert message, as indicated by the signature field. In some cases, the signature scheme may be a multisig signature scheme in which the N of M signatures, e.g. 3 of 5 signatures, are to be included and valid. In some cases, threshold signatures may be used.

Each signature should be over the contents of the alert message; however, the creation and validation of signatures poses an issues since at the point of signing the signature field is empty but at the point of validation it is populated. Accordingly, present application provides that a valid signature in this example is based on the alert message with a null signature field. To simplify for validation at the nodes, the alert message is to be serialized with no whitespace before being signed.

As indicated by operation 704, the alert administration service serializes the alert message having a null signature field. This creates a string without extraneous formatting or whitespace. That serialized alert message is then hashed in operation 706 and the resulting hash is signed using a private key held by the alert administration service in operation 708. The signing may be repeated with different private keys if multiple signatures are to be generated.

Once the digital signatures have been generated, then in operation 710 they are inserted into the signature object within the serialized alert message to create the signed serialized alert message. The signed serialized alert message is then inserted into the output field of an alert transaction. In a particular example, the signed serialized alert message is inserted into an OP_RETURN field of an alert transaction. In some implementations, the OP_RETURN field may include an alert code signalling that the transaction is an alert transaction, in addition to containing the signed serialized alert message. An example alert transaction with an OP_RETURN output script at index 0 is:

Alert transaction

| Inputs | Outputs |
|---|---|
| . . . | OP_FALSE_OP_RETURN 0x616C7274 alert-json |
| . . . | . . . |

In the above illustrative example, the code 0x616C7274 signals that it is an alert transaction. It is a 4-byte alert prefix that spells “alrt” in ASCII. Any other code could be used. It is followed by the alert JSON.

In some examples, the alert transaction generated in this manner may be propagated on the blockchain P2P network in the same way as a normal transaction. For instance, on the Bitcoin network, the alert transaction may be propagated using a tx P2P message, which will look to peer nodes like a normal transaction message. However, in this example, the alert administration service encapsulates or wraps the alert transaction within an alert P2P message. This may have the advantage that the P2P message will not be ignored by nodes and network elements that normally do not process transactions. For instance, some nodes may be configured to ignore or be excluded from tx P2P messaging, whereas they may be configured to receive and accept alert P2P messages. Operation 714 includes wrapping the alert transaction in an alert P2P message. The structure of an alert P2P message may be, in one example:

| Field Size | Name | Data Type | Description |
|---|---|---|---|
| variable | alert_txn | uint8_t[ ] | A raw serialized alert transaction |

In operation 716, the alert administration service transmits the alert P2P message to one or more peer nodes on a P2P network and, in this particular example, to one or more mining nodes on a blockchain network.

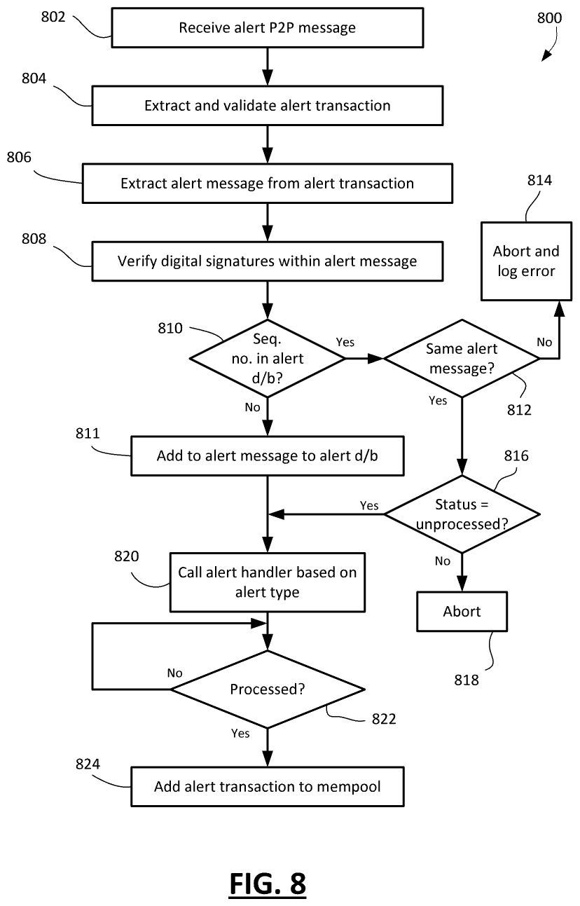

Reference is now made to FIG. 8, which shows, in flowchart form, one example method 800 of processing an alert message. The method 800 may be implemented using a network-connected computing device; in particular, a mining node that is part of the blockchain network. In some cases, the mining node may be a server or group of servers, such as mining node 556 (FIG. 5). The operations of the method 800 may be carried out by the mining node based on processor-executed software instructions stored in memory on the computing device. In some cases, the operations are carried out by the node software 600 (FIG. 6) and, in some cases, by the alert handler 602 (FIG. 6) and/or its sub-handlers.

In operation 802, the node receives an alert P2P message. In this example, the alert message is embedded in an alert transaction which is communicated within an alert P2P message. In another example, the alert transaction may be communicated directly in a transaction P2P message rather than being wrapped in an alert P2P message. In another situation, the alert transaction may be identified within a block being validated, either during block validation after another miner finds a proof-of-work, or during an IBD process.

In operation 804, the alert transaction is extracted and validated. In some cases, this may be carried out by the P2P messaging interface. It may extract the alert transaction and call the normal transaction validation process, such as ProcessTxMessageo, for example, just as it might for a newly received tx P2P message. Accordingly, the node verifies that the alert transaction meets protocol requirements and is a valid transaction. This may include determining whether the alert transaction already appears in the mempool at the node. If the alert transaction is already in the mempool, it indicates that the node has already received the alert transaction, validated it, and processed the alert message within the alert transaction. In this case, the method 800 may end and the duplicate alert transaction may be discarded.

The signed serialized alert message may be extracted from the alert transaction in operation 806. It may then be validated by the alert handler in operation 808, which may include verifying the one or more digital signatures within the signed serialized alert message using one or more public keys associated with the alert administration service.

Verification of signatures may be based on first extracting the digital signatures from the signature field of the signed serialized alert message. That is, the alert handler ensures the modified alert message includes a null signature field. It then hashes the modified serialized alert message to obtain a hash result. Based on the hash result and one or more public keys for the alert administration service, the alert hander can verify the validity of the digital signatures. The alert handler may be configured to determine which keys were in use at the time of the signing of the alert message, based for example on the timestamp.

In operation 810, the node determines whether the alert message is already in the alert database. This may include searching the alert database based on the sequence number. If the sequence number is found in the alert database, then the node may determine whether it relates to the same alert message in operation 812. If not, then an error has occurred because more than one alert purports to have the same sequence number and the processing may be aborted and an error logged in operation 814.

If it is the same alert that has already been logged in the alert database, then the node has simply received another copy of it. In this case, the node determines whether it completed processing of the previously-recorded alert message in operation 816. The status may indicate PROCESSED or ERROR in that circumstance, depending on the result from the sub-handler. If the previously-recorded alert message has not yet been processed, the status indicates UNPROCESSED. The alert may be unprocessed because the asynchronous alert processing has not yet been completed, or because the processing was interrupted and failed to complete, or because of an error in updating the alert database. In any case, if the processing is incomplete, then the method continues. However, if the processing is complete, then in operation 818 the processing is aborted since this alert message has already been handled.

If in operation 810 it is determined that the alert message is not already in the database, then in operation 811, the alert message is recorded in the alert database and assigned a status of UNPROCESSED.

In operation 820, the alert handler calls the appropriate sub-handler for processing the instruction in the alert message based on the alert type. Note that if the sub-handler is already trying to process the alert message then this may result in re-sending the same alert message to the sub-handler and the sub-handler will be configured to gracefully handle the duplicate request.

The processing of the alert continues until the sub-handler returns a result in operation 822, which may include a message confirming the alert was successfully processed or an error message. If the alert message is successful processed, then the alert handler ensures the alert transaction is added to the local mempool in operation 824. It may update the alert database to change the alert status to PROCESSED. In some cases, it may also record any additional data returned by the alert sub-handler, such as any warning or error messages. In some cases, the alert handler may notify a P2P interface layer that the alert transaction or the alert P2P message are to be distributed to other peer nodes.

It will be appreciated that in some implementations the method 800 may be modified to perform one or more operations in parallel or to change the order in which some of the operations are performed without necessarily impacting the overall operation of the method 800. In the above process, the alert message processing may happen asynchronously so as not to tie up or block further transaction validations. The alert transaction validation may complete before the alert message has been processed by a sub-handler. The alert transaction is not necessarily added to the mempool on completion of the transaction validation process, as might occur with a normal transaction, since the alert transaction is added to the mempool partly to signal that the alert has been successfully processed by the node. Once the status of the alert message=PROCESSED, then the alert handler may cause the alert transaction to be added to the mempool. If the alert transaction is added to the mempool, the node may not announce it (INV) to other peers.

The processing of alerts found in a block during block validation may be a similar but slightly more complex process based on the possibility of there being more than one alert in a block. In some cases, alerts may cancel each other, such as if there is an alert message imposing a freeze order on a TXOUT and then a subsequent alert message implementing an unfreeze order on the same TXOUT. Accordingly, during block validation when alerts transactions are identified they may be added to a running list of possible new alerts. The alert transactions may undergo transaction validation just as normal transactions would. Once block validation is completed successfully, then the alert handler may process alerts in the order in which they appear in the block, as though they were received via the P2P interface in that order. The alert transactions, even if validated and processed, are not added to the mempool since they are already in a block. If the alert processing returns an error from an alert handler, the block may be rejected as invalid as only successfully processed alerts should appear in valid blocks. Any alerts found in the block that the node does not already have it its alert database are treated as new alert messages and are processed accordingly.

As mentioned above, in some cases an order from an authority may specify one or more particular digital assets by way of address, e.g. wallet addresses, pay-to-public-key-hash (P2PKH) addresses, pay-to-script-hash (P2SH) addresses, or other forms of address. In some cases, the order may specify transaction outpoints rather in addition to or instead of addresses. An address indexer at the alert administration service, or to which the service has access, may be configured to resolve transaction outpoints from addresses, i.e. to identify transaction outpoints sending digital assets to a particular address. It may further be configured to trace the children of a transaction outpoint (TXOUT), i.e. to find a transaction outpoint used as an input to a later transaction and to identify the outputs of that later transaction as linked to the TXOUT as children outpoints. The indexer may be standalone or separate component accessible through a REST API or similar interface. It may connect to a blockchain node instance to listen for new blocks and retrieve block data. The address indexer uses data from the blocks on the current chain as well as unconfirmed transactions in a mempool. In some other implementations, the address indexing operations may be implemented at the mining node level, meaning that the alert administration service may an alert such a as a freeze order message identifying addresses and the mining nodes may carry out the function of tracing specific outpoints that map to those addresses.

In some cases, the address indexer may be configured to receive an address and a time and will provide in reply a set of TXOUTs, each of which can be specified as a pair formed from transaction identifier (TXID) and output index (vout). The set will reference TXOUTs created in blocks with time no earlier than the time specified.

In some cases, the address indexer may be configured to provide child data with regard to TXOUTs. In this regard, it may provide a function or API in which it receives a TXOUT and provides an array or other data structure specifying the TXOUT, and a set of child TXOUTs. It may further provide information regarding the blocks in which the TXOUT was used to generate the child TXOUTs. An array may be provided since a single TXOUT may be spent multiple times in presence of forks.

In some cases, the alert generation service may be configured or instructed to freeze or unfreeze child outpoints in addition to any specific transaction outpoints. In such cases, the address indexer may be used to trace digital assets passing to new transaction outpoints when generating the alert message. In one example implementation, this may be carried out by:
a) Scanning all blocks from TXOUT creation time up to the latest time. This can be quite time consuming. Scanning the whole blockchain could require several hours and a lot of resources;
b) Using off-the-shelf graph database or custom implementation and updating relations as soon as new block arrives (requires more storage upfront);
c) Using series of calls to existing address/output indexer (such as ElectrumX server) and fully indexed blockchain node to perform recursive lookup for each frozen asset. Because of address reuse this may end up being slow; or
d) Building a custom indexer component that would index addresses and how outputs are spent (and new outputs are created).

Whether an alert message is being generated to freeze an address or specific transaction outpoints, the alert administration service may start by identifying the affected transaction outpoints. It may then trace any transactions that use those transaction outpoints, i.e. children outpoints, and the children outpoints may then be added to the list of transaction outpoints. Note that the new address to which the children outpoints allocate assets is not added, since this may implicate other unrelated assets held by that address.

The responsibility for identifying children transaction outpoints may rest with the alert administration service in these examples. This has the advantage that mining nodes may therefore run non-indexed or pruned nodes, they do not need address indexers or child discovery tracing capability, and the list of outpoints in the alert message digitally signed by the alert administration service is static and common to all miners, thereby avoiding risk of inconsistent freezes and chain forking. The downside is that subsequent movement of assets from the identified outpoints during the time from generation of the alert message and distribution of it to miners and its implementation, may result in evading the freeze. If additional child outpoints are to be included in an alert message after the first alert message has been distributed, the alert administration service may generate and send a second or subsequent alert message.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A computer-implemented method, comprising:
identifying, at a mining node in a blockchain network, that a transaction is an alert transaction;
extracting an alert message from an output field of the alert transaction;
validating, using one or more alert administrator public keys, one or more signatures within the alert message; and
based on the one or more signatures being validated, processing an instruction within the alert message, wherein processing includes one of invaliding a block, banning a peer node, freezing a transaction outpoint, or validating and propagating a confiscation transaction.

2. The method of claim 1, wherein identifying that a transaction is an alert transaction is at least partly based on identifying an alert code in the output field.

3. The method of claim 1, wherein the alert message includes an alert type field signaling one of a predefined set of alert types.

4. The method of claim 3, wherein the predefined set of alert types include, at least, an information alert, a ban peer alert, an unban peer alert, a freeze alert, an unfreeze alert, an invalidate block alert, a reconsider block alert, and a confiscate alert.

5. The method of claim 1, wherein the alert message is a signed serialized alert message and wherein validating the one or more signatures includes extracting the one or more signatures from the signed serialized alert message leaving a null signature field to result in a modified serialized alert message, hashing the modified serialized alert message to obtain a hash result, and verifying the one or more signatures using the hash result and corresponding one or more public keys associated with an alert administration service.

6. The method of claim 1, further comprising receiving an alert P2P message over the blockchain network and extracting the alert transaction from the alert P2P message.

7. The method of claim 1, wherein the freezing the transaction output includes obtaining the transaction outpoint from the instruction within the alert message and recording the transaction output as frozen within an order database.

8. The method of claim 1, wherein the validating and propagating a confiscation transaction includes extracting the confiscation transaction from within the alert message and whitelisting the confiscation transaction within an order database, and wherein validating and propagating the confiscation transaction includes validating based on its inclusion in the whitelist.

9. A computer-implemented method, comprising:
generating an alert message at an alert administration service, the alert message including a null signature field;
serializing and hashing the alert message to generate a hash result;
signing the hash result using one or more private keys to generate one or more digital signatures;
inserting the one or more digital signatures into the null signature field to produce a signed serialized alert message;
inserting the signed serialized alert message into an output field of a blockchain transaction; and
propagating the blockchain transaction on a blockchain network.

10. The method of claim 9, wherein the blockchain transaction is an alert transaction and wherein propagating includes wrapping the alert transaction in an alert P2P message and transmitting the alert P2P message on the blockchain network to a plurality of mining nodes.

11. The method of claim 9, wherein the blockchain transaction is an alert transaction, and wherein the output field includes an alert code and the signed serialized alert message.

12. The method of claim 9, wherein the alert message includes an alert type and an instruction.

13. The method of claim 12, wherein the alert type is one of a set of predefined alert types, and wherein the predefined set of alert types include, at least, an information alert, a ban peer alert, an unban peer alert, a freeze alert, an unfreeze alert, an invalidate block alert, a reconsider block alert, and a confiscate alert.

14. A computing device, the computing device including:
one or more processors;
memory; and
computer-executable instructions stored in the memory that, when executed by the one or more processors, cause the processors to:
identify, at a mining node in a blockchain network, that a transaction is an alert transaction;
extract an alert message from an output field of the alert transaction;
validate, using one or more alert administrator public keys, one or more signatures within the alert message; and
based on the one or more signatures being validated, process an instruction within the alert message, wherein processing includes one of invaliding a block, banning a peer node, freezing a transaction outpoint, or validating and propagating a confiscation transaction.

15. A computer-readable medium storing processor-executable instructions, the processor-executable instructions including instructions that, when executed by one or more processors, cause the processors to:
identify, at a mining node in a blockchain network, that a transaction is an alert transaction;
extract an alert message from an output field of the alert transaction;
validate, using one or more alert administrator public keys, one or more signatures within the alert message; and
based on the one or more signatures being validated, process an instruction within the alert message, wherein processing includes one of invaliding a block, banning a peer node, freezing a transaction outpoint, or validating and propagating a confiscation transaction.

16. The computing device of claim 14, wherein the instructions, when executed, are to cause the one or more processors to identify that a transaction is an alert transaction at least partly based on identifying an alert code in the output field.

17. The computing device of claim 14, wherein the alert message includes an alert type field signaling one of a predefined set of alert types.

18. The computing device of claim 14, wherein the alert message is a signed serialized alert message and wherein the instructions, when executed, are to cause the one or more processors to validate the one or more signatures by:
extracting the one or more signatures from the signed serialized alert message leaving a null signature field to result in a modified serialized alert message, hashing the modified serialized alert message to obtain a hash result, and
verifying the one or more signatures using the hash result and corresponding one or more public keys associated with an alert administration service.

19. A computing device, the computing device including:
one or more processors;
memory; and
computer-executable instructions stored in the memory that, when executed by the one or more processors, cause the processors to:
generate an alert message at an alert administration service, the alert message including a null signature field;
serialize and hash the alert message to generate a hash result;
sign the hash result using one or more private keys to generate one or more digital signatures;
insert the one or more digital signatures into the null signature field to produce a signed serialized alert message;
insert the signed serialized alert message into an output field of a blockchain transaction; and
propagate the blockchain transaction on a blockchain network.

20. The computing device of claim 19, wherein the blockchain transaction is an alert transaction and wherein the instructions, when executed, are to cause the one or more processors to propagate by wrapping the alert transaction in an alert P2P message and transmitting the alert P2P message on the blockchain network to a plurality of mining nodes.
